(19) United States
(12) Patent Application Publication
(10) Pub. No.: US 2014/0338174 A1
(43) Pub. Date: Nov. 20, 2014

(54) METHOD AND DEVICE FOR ASSEMBLING AND DISASSEMBLING THREADED PIPES

(71) Applicant: Robotic Drilling Systems AS, Sandnes (NO)

(72) Inventor: Kenneth Mikalsen, Bryne (NO)

(21) Appl. No.: 14/360,826

(22) PCT Filed: Nov. 28, 2012
(86) PCT No.: PCT/NO2012/050238

§ 371 Date: May 27, 2014

(30) Foreign Application Priority Data
Nov. 29, 2011 (NO) 20111647
Nov. 27, 2012 (NO) 20121417

(51) Int. Cl. B23P 19/04

(52) U.S. Cl. CPC B23P 19/04
USPC 29/428; 29/705

(57) ABSTRACT

A device for assembling or disassembling a first threaded pipe (1) to or from a second threaded pipe (2) is described, the device including a first machine (12) arranged to lift the first threaded pipe (1), and the device being characterized by the first machine (12) being arranged to lift the first threaded pipe (1) with a force corresponding to the net weight of the first threaded pipe (1); and the first machine being arranged to lift the first threaded pipe (1) with a force equal to the difference between the weight force from the net weight of the first threaded pipe and a desired axial contact force between the first threaded pipe (1) and the second threaded pipe (2) during the make-up or break-out operation, the desired axial contact force being smaller than the weight force from the net weight of the first threaded pipe (1). A method of assembling or disassembling threaded pipes (1, 2) is described as well.

This invention relates to a device for use when assembling or disassembling a first threaded pipe to or from a second threaded pipe. The invention also relates to a method of assembling or disassembling threaded pipes.

The invention is particularly relevant when assembling and disassembling pipe strings that are used for drilling in the ground.

According to the prior art, it is common to let a vertical pipe which is to be screwed together with an existing pipe string rest with all its weight against the corresponding threads in the pipe string during the entire make-up operation. During the screwing operation, it is further common to control the relative rate of displacement between the machines holding the pipe and the pipe string, at a rate corresponding to the rotational speed multiplied by the pitch of the threads.

Prior-art devices and methods may lead to damage on the threads if the corresponding threads are not concentric during stabbing. The problem is increased with mechanized handling of the pipes, in which the pipe to be assembled is positioned against the pipe string In a relatively rigid way compared with earlier practice In which the operation was manual to a greater degree. A large axial force, and thereby large friction, on the threads further entails the need for a greater torque in order to assemble or disassemble the threaded pipes.

The invention has for its object to remedy or reduce at least one of the drawbacks of the prior art.

The object Is achieved in accordance with the invention through the features which are specified in the description below and in the claims that follow.

In a first aspect, the invention relates to a device for assembling or disassembling a first threaded pipe to or from a second threaded pipe, the device including:

a first machine arranged to lift the first threaded pipe, characterized by the first machine being arranged to lift the first threaded pipe with a force corresponding to the net weight of the first threaded pipe; and the first machine being arranged to lift the first threaded pipe with a force equal to the difference between the net weight of the first threaded pipe and a desired axial contact force between the first threaded pipe and the second threaded pipe during a make-up or break-out operation, wherein the desired axial contact force is smaller than the weight force from the net weight of the first threaded pipe.

In a second aspect, the invention relates to a method for use when assembling or disassembling a first threaded pipe to or from a second threaded pipe, the method including the step of:
putting load on the threads of the threaded pipes with an axial contact force during a make-up or break-out operation, the axial contact force being smaller than the net weight of the first threaded pipe, characterized by the method further including the following steps:
determining the weight force with which the threaded pipe is to be lifted to keep stationary a first threaded pipe which is to be assembled or disassembled; and
letting a first machine lift the first threaded pipe, which is to be assembled or disassembled, with a force equal to the difference between the weight force from the net weight of the threaded pipe and the axial contact force during the make-up or break-out operation. Here, by a threaded pipe is meant a single threaded pipe, a pipe assembly of several threaded pipes or a pipe string.

By putting load on the pipe threads with an axial contact force appropriate for the purpose, which is smaller than the force generated by the net weight of a first threaded pipe, it is possible to carry out the assembling and disassembling of pipe thread connections in a gentle manner. The weight of a threaded pipe assembly of, for example, three threaded pipes is considerable and often in the order of one tonne. If drill collars are used, the weight may approach 10 tonnes.

Often, the pipe threads are contaminated by Impure fluid, which may cause undesired wear on the threads if the contact force between the threads is superfluously large.

The method is the most relevant when the threaded pipes are in a vertical position, but may also be used when the threaded pipes are in a horizontal position, for example when individual threaded pipes are being screwed together into a threaded pipe assembly.

The weight force, that is to say the vertical force generated by the net weight of the first threaded pipe, may be determined by, for example, weighing the threaded pipe before it is screwed together with the second threaded pipe. If it is a case of disassembling a pipe string, the weights of the individual threaded pipes are known from when the pipe string was assembled.

The method may include letting the direction of the contact force coincide with the screwing direction. When screwing together threaded pipes, it is desirable to let the contact force act in the direction of screwing together. During disassembly, the contact force may also act in the direction of screwing together, but it will most often be advantageous to let it act in in the unscrewing direction. In that case, the lifting device must lift with a force equal to the sum of the weight force and the contact force.

In one non-limiting embodiment, the first threaded pipe may have a weight in the order of 3000 kg. In order not to load the threads of the two threaded pipes with this weight, the first machine, which may be a power tong or a top-drive rotary machine, for example, is used to apply an upward force to the first threaded pipe corresponding to the net weight of the first threaded pipe, so that the weight of the threaded pipe is substantially balanced by the first machine. When the two threaded pipes are to be assembled, the upward force from the first machine may be reduced somewhat so that, for example, 100 kg rests on the threaded connections during make-up. This means that the first machine lifts upwards with 2900 kg during make-up. When the same two threaded pipes are being disassembled, the first machine may lift the first threaded pipe upwards with a force which is somewhat larger than the net weight of the first threaded pipe, for example with 3100 kg, so that a 100 kg axial force is applied to the threaded connection in the unscrewing direction. By eliminating or reducing the vertical force introduced by the first threaded pipe, it will be possible to go easy on the threads during assembly and disassembly, as substantially less frictional force is produced between the threads of the two threaded pipes. This also reduces the risk of damage at the first contact between the two threaded pipes.

The method may include letting a first machine, when assembling a first threaded pipe, move the first threaded pipe towards a second threaded pipe until the first threads of the first threaded pipe contact the second threads of the second threaded pipe before the predetermined contact force is activated.

The method is equally well suited for both cylindrical and conical threads.

The method according to the invention solves a long-felt problem in the mechanized assembling of threaded pipes, in particular in connection with assembling a threaded pipe or a threaded-pipe assembly in a vertical position to a pipe string.

In what follows, an example of a preferred method is described, which is visualized in the accompanying drawings, In which:

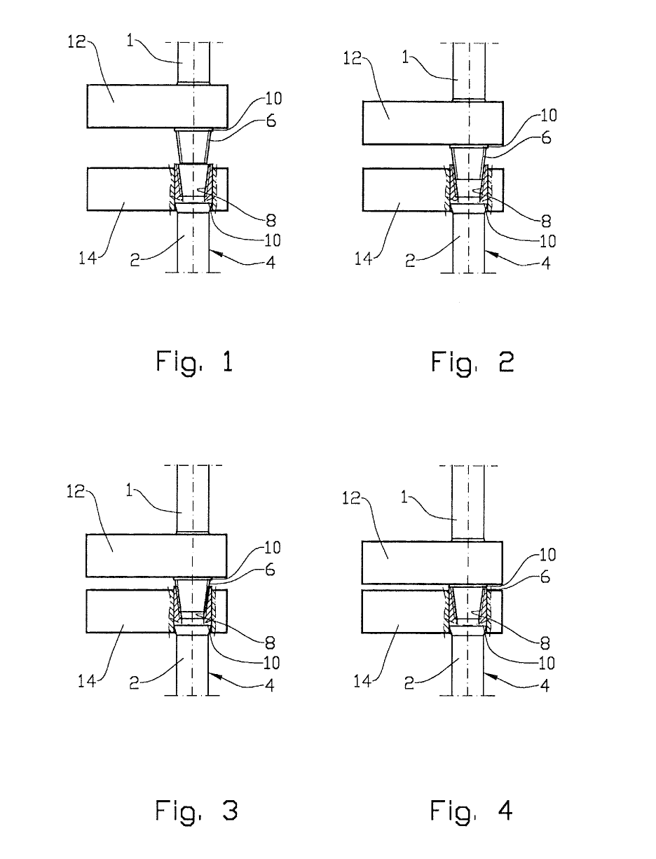

FIG. 1 shows, partially in section, a first threaded pipe which is ready to be assembled to a second threaded pipe by means of a method according to the invention;

FIG. 2 shows the same as FIG. 1, but after the thread of the first threaded pipe and the thread of the second threaded pipe have made contact with each other;

FIG. 3 shows the same as FIG. 1, but after the threaded pipes have partially been screwed together; and

FIG. 4 shows the same as FIG. 1, but after the first threaded pipe has been made up completely with the second threaded pipe.

In the drawings, the reference numeral 1 indicates a first threaded pipe which is arranged to be screwed together with a second threaded pipe 2.

As usual when building up a pipe string 4, threaded pipes 1, 2 are used, in which the first thread 6 of the threaded pipes 1, 2 is constituted by a conical external thread, and a second thread 8 of the threaded pipes 1, 2 constitutes a conical internal thread complementarily fitting the first thread 6.

In the case of a pipe string 4 of the kind that is shown in FIGS. 1-4, which is to be used as a drill string, the threads 6, 8 are at a collar portion 10 of the threaded pipe 1, 2 which has been given a larger diameter than the rest of the threaded pipe 1, 2. The method is equally well suited for a threaded pipe 1, 2 which does not have a collar portion 10 of a larger diameter than the rest of the threaded pipe 1, 2.

In the drawings, the first threaded pipe 1 is held by a first machine 12 in the form of a power tong. However, the first machine 12 may be constituted by a top-drive drilling machine, by a so-called “spinner”, by a robot or by other known machines that are used for the purpose. The alternative machines are not shown in the drawings.

In the drawings, the second threaded pipe 2 is held by a second machine 14 in the form of a back-up tong. However, the second machine 14 may be constituted by slips, a robot or other known machines that are used for the purpose. The alternative machines are not shown in the drawing.

The machines 12, 14 are shown schematically in the figures.

The first machine 12 and the second machine 14 may constitute parts of a machine not shown, for example in the form of a so-called “iron roughneck”.

The first machine 12 and the second machine 14 are connected, in a manner known per se, to a control not shown or to individual controls that communicate via a network.

When the first threaded pipe 1 is to be assembled to the second threaded pipe 2, the weight force of the first threaded pipe 1 is determined first by weighing the threaded pipe 1. Often, the weight of the first threaded pipe 1 is already known from the assembly plan of the pipe string 4. Otherwise, the first threaded pipe 1 may be weighed in a pipe manipulator not shown, for example during transport to the place of installation, or in the first machine 12.

is The first threaded pipe 1 is then moved towards the second threaded pipe 2 until the first thread 6 contacts the second thread 8, see FIG. 2. It can be registered that the first thread 6 is in contact with the second thread 8, for example by the first machine 12 registering a load reduction. Alternatively, the length of displacement of the first threaded pipe 1 from a particular point may be known, so that the position of the first threaded pipe 1, when hitting the second threaded pipe 2, is known in advance.

The lifting force of the first machine 12 is then reduced to the difference between the weight force and the contact force, so that the first thread 6 rests against the second thread 8 with the predetermined contact force while the threads 6, 8 are screwed together, see FIG. 3. Of course, it is possible to change the desired contact force as the threads 6, 8 are being screwed together.

When the first threaded pipe 1 and the second threaded pipe 2 have been screwed together, see FIG. 4, the threads 6, 8 are tightened to the desired torque by the first machine 12 while the second machine 14 holds the second threaded pipe 2 stationary.

1. A device for assembling or disassembling a first threaded pipe to or from a second threaded pipe, the device including:
a first machine arranged to lift the first threaded pipe;
a second machine arranged to hold the second threaded pipe; and
weighting means for determining the net weight of the first pipe, wherein the first machine is arranged to lift the first threaded pipe with a force corresponding to the net weight of the first threaded pipe, and is arranged to lift the first threaded pipe with a force equal to the difference between the net weight of the first threaded pipe and an axial contact force between the first threaded pipe and the second threaded pipe during a make-up or break-out operation, the axial contact force being smaller than the weight force from the net weight of the first threaded pipe.

2. A method for assembling or disassembling a first threaded pipe to or from a second threaded pipe, wherein the method comprises the following steps:
by weighing the first threaded pipe, determining the weight force with which to lift the first threaded pipe in order to keep it stationary;
using a second machine, holding the second threaded pipe;
using a first machine, lifting the first threaded pipe into contact with the second threaded pipe, so as to a load on the threads of the threaded pipes with an axial contact force smaller than the net weight of the first threaded pipe; and
using the first machine lifting the first threaded pipe with a force equal to the difference between the weight force from the net weight of the first threaded pipe and the axial contact force during the make-up or break-out operation.

3. The method in accordance with claim 2, wherein the method includes letting the direction of the contact force coincide with the screwing direction.

4. The method in accordance with claim 2, the method including, when assembling the first threaded pipe, letting the first machine move the first threaded pipe towards the second threaded pipe until the first threads of the first threaded pipe contact the second threads of the second threaded pipe before the axial contact force is activated.
